(19) United States
(12) Patent Application Publication
(10) Pub. No.: US 2026/0194740 A1
(43) Pub. Date: Jul. 9, 2026

(54) MICROSCOPE SYSTEM AND SHADED IMAGE ACQUISITION METHOD

(71) Applicant: Evident Corporation, Tatsuno-machi (JP)

(72) Inventors: Motohiro SHIBATA, Kamiina-gun (JP); Yosuke TANI, Kamiina-gun (JP); Hirofumi HORI, Kamiina-gun (JP)

(73) Assignee: Evident Corporation, Tatsuno-machi (JP)

(21) Appl. No.: 19/556,983

(22) Filed: Mar. 4, 2026

Related U.S. Application Data
(63) Continuation of application No. PCT/JP2025/032523, filed on Sep. 16, 2025.

(30) Foreign Application Priority Data
Nov. 1, 2024 (JP) 2024-193144

(51) Int. Cl. G02B 21/36; G02B 21/06; G06T 7/507; G02B 21/24; G02B 21/26

(52) U.S. Cl. CPC G02B 21/367; G02B 21/06; G06T 7/507; G02B 21/241; G02B 21/26; G06T 2207/10056

(57) ABSTRACT

An imaging device sequentially acquires images of an observation target at a predetermined frame rate, and sequentially outputs trigger signals synchronized with frames. An illumination device can irradiate the observation target with illumination light from a plurality of illumination directions rotated about an optical axis of the objective lens around the optical axis, and switches the illumination directions according to the trigger signals. A computer generates a composite image representing a shape of the observation target on the basis of a plurality of images of the observation target acquired when the observation target is irradiated with the illumination light from the plurality of illumination directions.

### CROSS REFERENCE TO RELATED APPLICATIONS

This application is a continuation application of PCT/JP2025/032523, filed September 16, 2025, which claims the benefit of Japanese Patent Application No. 2024-193144, filed November 1, 2024, the entire contents of both of which are incorporated herein by this reference.

### FIELD

The present disclosure relates to a microscope system and a shaded image acquisition method.

### BACKGROUND

In an inspection process using a microscope, a shaded image may be created in order to facilitate the discovery of scratches and defects. However, in a case where there is a texture of an observation target or reflection of light from the observation target, it is difficult to find a scratch or a defect. Therefore, a photometric stereo method of estimating a normal vector of an observation target from a plurality of images having different illumination directions is adopted. By obtaining the normal vector by the photometric stereo method and assigning brightness and darkness of the observation target according to the inclination of the normal, it is possible to construct a shaded image that is not affected by the texture or reflection of light.

For example, JP 2015-232482 A (hereinafter, referred to as Patent Literature 1) discloses a method of acquiring a shaded image while switching a lighting pattern by sending a trigger signal from a host processor to a camera and an illumination device.

### SUMMARY

A microscope system according to one aspect of the present disclosure includes: an optical system including an objective lens; an imaging device configured to sequentially acquire images of an observation target via the optical system at a predetermined frame rate and sequentially output trigger signals synchronized with frames during acquisition of the images of the observation target; an illumination device configured to perform non-coaxial epi-illumination capable of irradiating the observation target with illumination light from a plurality of illumination directions rotated about an optical axis of the objective lens around the optical axis, the illumination device configured to receive the trigger signals output from the imaging device and switch the illumination directions according to the trigger signals; and a computer configured to combine the images of the observation target acquired by the imaging device, the computer configured to generate a composite image representing a shape of the observation target on the basis of a plurality of images of the observation target acquired when the observation target is illuminated by the illumination light from the plurality of illumination directions.

A microscope system according to another aspect of the present disclosure includes: an imaging device configured to acquire images of an observation target at a predetermined frame rate and sequentially output trigger signals synchronized with frames at an end of exposure of each frame; an illumination device configured to perform illumination with a multi-directional illumination pattern for irradiating the observation target with light from at least two different directions while changing an irradiation direction with respect to the observation target every time a trigger signal is received, and capable of changing an angle of the irradiation direction of light of the multi-directional illumination pattern; a rotation stage on which the observation target is placed and rotatable about an optical axis of an optical system of the imaging device; and a computer configured to generate a composite image by combining at least two images obtained by imaging, by the imaging device, the observation target illuminated from the at least two different directions with the multi-directional illumination pattern, wherein the two images are obtained by live imaging of the imaging device, the computer sequentially generates the composite image with two images by the multi-directional illumination pattern as a set, and the illumination device changes the angle of the irradiation direction of light of the multi-directional illumination pattern so that the illumination direction with respect to the observation target does not change before and after rotation of the rotation stage.

A shaded image acquisition method according to one aspect of the present disclosure is a shaded image acquisition method of a microscope system including an imaging device, an illumination device, and a computer, the method including: sequentially acquiring, by the imaging device, images of an observation target at a predetermined frame rate, and sequentially outputting, by the imaging device, trigger signals synchronized with frames during acquisition of the images of the observation target; performing, by the illumination device, non-coaxial epi-illumination to irradiate the observation target with illumination light, receiving, by the illumination device, the trigger signals output from the imaging device, and switching, by the illumination device and according to the trigger signals, between irradiating the observation target with the illumination light from a first illumination direction and irradiating the observation target with the illumination light from a second illumination direction that is symmetric to the first illumination direction with respect to an optical axis of an optical system of the imaging device; and generating, by the computer, a shaded image with shading representing a shape of the observation target as a composite image by combining an image of the observation target acquired when the observation target is irradiated with the illumination light from the first illumination direction and an image of the observation target acquired when the observation target is irradiated with the illumination light from the second illumination direction.

A non-transitory computer-readable recording medium according to an aspect of the present disclosure stores a shaded image acquisition program that causes a computer to perform a process including: causing an imaging device that sequentially acquires images of an observation target at a predetermined frame rate to sequentially output trigger signals synchronized with frames during acquisition of the images of the observation target; and causing an illumination device that performs non-coaxial epi-illumination to irradiate the observation target with illumination light to switch between irradiating the observation target with the illumination light from a first illumination direction and irradiating the observation target with the illumination light from a second illumination direction that is symmetric to the first illumination direction with respect to an optical axis of an optical system of the imaging device, according to the trigger signals output from the imaging device, and combining an image of the observation target acquired when the observation target is irradiated with the illumination light from the first illumination direction and an image of the observation target acquired when the observation target is irradiated with the illumination light from the second illumination direction to generate a shaded image with shading representing a shape of the observation target as a composite image.

### BRIEF DESCRIPTION OF DRAWINGS

FIG. 1 is a block diagram illustrating a microscope system according to a first embodiment of the present disclosure;

FIG. 2 is an explanatory diagram illustrating an example of a configuration of an illumination unit of an illumination device;

FIG. 3 is an explanatory diagram illustrating examples of an illumination pattern of the illumination unit;

FIG. 4 is a block diagram illustrating an example of configurations of an imaging device and the illumination device;

FIG. 5 is a flowchart for explaining an operation of the first embodiment;

FIG. 6 is a timing chart for explaining the operation of the first embodiment;

FIG. 7 is a flowchart illustrating a modification of the first embodiment;

FIG. 8 is an explanatory diagram illustrating a modification of the first embodiment;

FIG. 9 is a flowchart for explaining a second embodiment;

FIG. 10 is a flowchart for explaining a third embodiment;

FIG. 11 is an explanatory diagram for explaining a fourth embodiment;

FIG. 12 is an explanatory diagram for explaining a fifth embodiment; and

FIG. 13 is an explanatory diagram illustrating an example of an operation device that can be employed as an input unit in FIG. 1.

### DESCRIPTION OF EMBODIMENTS

Hereinafter, embodiments of the present disclosure will be described in detail with reference to the drawings.

In the proposal of Patent Literature 1, the lighting pattern is switched by the trigger signal from the host processor, and every time the lighting pattern is switched, a relatively long time is required for signal processing such as development in the camera, so that there is a problem that the shaded image cannot be acquired in a short time.

### First Embodiment

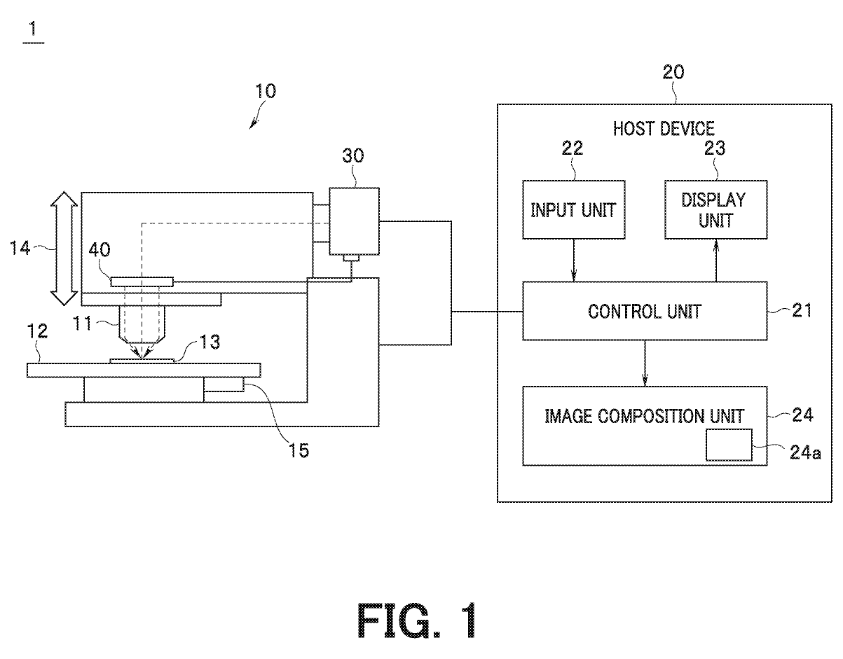

FIG. 1 is a block diagram illustrating a microscope system according to a first embodiment of the present disclosure. In the present embodiment, a trigger signal at the frame rate is generated from an imaging device constituting a microscope system, and a shaded image is generated by combining a plurality of images acquired by performing imaging while switching an illumination pattern of illumination light by the trigger signal. By performing exposure processing performed with different illumination patterns in accordance with a frame rate and signal processing on an imaging signal in parallel, it is possible to generate a shaded image in a short time.

In FIG. 1, a microscope system 1 includes a microscope 10 and a host device 20 that controls the microscope 10. The microscope 10 and the host device 20 are hardware. The host device 20 includes a control unit 21, an input unit 22, a display unit 23, and an image composition unit 24. The input unit 22 and the display unit 23 are hardware. A processor using a central processing unit (CPU), a field programmable gate array (FPGA), or the like may operate as the control unit 21 and the image composition unit 24. The processor may operate as the control unit 21 and the image composition unit 24 by executing a program stored in a memory (not illustrated). The processor and the memory are hardware. A hardware electronic circuit may implement some or all of the functions of the control unit 21 and the image composition unit 24.

The microscope 10 is an enlarged observation device capable of enlarging and observing a specimen 13, and includes a stage 12 on which the specimen 13 is placed and an objective lens 11. Furthermore, the microscope 10 also includes a focusing device 14 for adjusting the distance between the objective lens 11 and the specimen 13 and focusing on the specimen 13. The focusing device 14 changes the distance between the position of the objective lens 11 used for observation and the stage 12 in the direction of an optical axis. Note that the focusing device 14 may have a mechanism for moving the objective lens 11 with respect to the fixed stage 12, or may have a mechanism for moving the stage 12 with respect to the fixed objective lens 11, and is indicated by an arrow indicating a movable direction of the focusing device 14 in FIG. 1.

The stage 12 and the focusing device 14 are driven and controlled by the control unit 21 of the host device 20. The stage 12 may be a motorized stage that moves in a XY direction orthogonal to an optical axis of the objective lens 11 used for observation. Furthermore, the stage 12 may be a rotation stage configured to be rotatable about the optical axis of the objective lens 11 (hereinafter, simply referred to as the optical axis) under the control of the control unit 21 in a state where the specimen 13 to be observed is placed. In addition, a rotary encoder 15 may be provided in proximity to the stage 12. The rotary encoder 15 is configured to detect the rotation angle of the stage 12 and transfer the detection result to the control unit 21. The objective lens 11, the stage 12, the focusing device 14, and the rotary encoder 15 are hardware.

The control unit 21 can arrange the specimen 13 at an arbitrary position or in an arbitrary direction by moving the stage 12 in the XY direction and driving the stage 12 by controlling a motor (not illustrated) that rotates the stage 12.

An illumination device 40 includes a light source such as a light emitting diode (LED), and can irradiate the specimen 13 with illumination light via the objective lens 11. The illumination device 40 is hardware. As will be described later, the illumination device 40 is configured to be able to illuminate the specimen 13 with a plurality of illumination patterns. The control unit 21 can generate a light emission control signal for controlling turning-on of the light source of the illumination device 40. The illumination device 40 is controlled by the light emission control signal from the control unit 21, and can perform illumination with a plurality of illumination patterns.

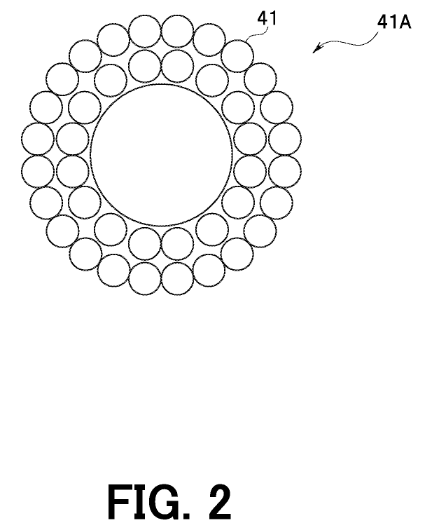

FIG. 2 is an explanatory diagram illustrating an example of a configuration of an illumination unit 41A of the illumination device 40. FIG. 2 illustrates a planar shape of the illumination unit 41A as viewed from the stage 12 side.

The illumination device 40 includes the illumination unit 41A including a plurality of LEDs 41. The illumination unit 41A is a lighting fixture that performs non-coaxial epi-illumination in which a light emitting surface is formed in a ring shape. In the example of FIG. 2, the illumination unit 41A is configured by arranging a plurality of LEDs each having a circular light emitting surface in two rows in a ring shape along the circumference. Each LED 41 can be individually controlled to emit light based on the light emission control signal from the control unit 21. Note that the configuration of the illumination unit 41A is an example, and the shape, size, number, and the like of the light emitting surface of the LED 41 can be appropriately set. The illumination unit 41A may be configured to be able to change the pattern of the illumination direction with respect to the specimen 13.

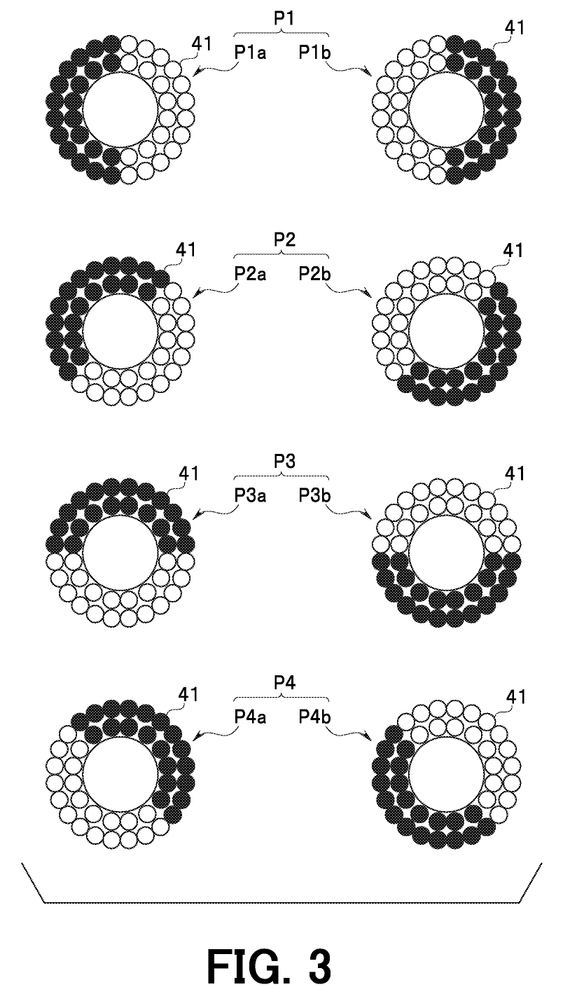

FIG. 3 is an explanatory diagram illustrating examples of an illumination pattern of the illumination unit 41A. In FIG. 3, the LED 41 that is turned on is illustrated as unfilled, and the LED 41 that is turned off is illustrated as filled. A set of illumination patterns P1 is composed of the illumination pattern P1a and the illumination pattern P1b, a set of illumination patterns P2 is composed of the illumination pattern P2a and the illumination pattern P2b, a set of illumination patterns P3 is composed of the illumination pattern P3a and the illumination pattern P3b, and a set of illumination patterns P4 is composed of the illumination pattern P4a and the illumination pattern P4b.

Note that each of the illumination patterns P1 to P4 is used to generate a shaded image. In the following description, these respective illumination patterns P1 to P4 are referred to as multi-directional illumination patterns P1 to P4. Further, one of the pair of illumination patterns included in a multi-directional illumination pattern is referred to as a first illumination pattern, and the other is referred to as a second illumination pattern. In addition, the illumination direction by the first illumination pattern is defined as a first illumination direction, and the illumination direction by the second illumination pattern is defined as a second illumination direction.

The multi-directional illumination pattern P1 includes an illumination pattern P1a (first illumination pattern) that turns on the plurality of adjacent LEDs 41 (first-group LEDs 41) on one side, constituting one half of all the LEDs 41, and turns off the plurality of LEDs 41 (second-group LEDs 41) of the remaining half located symmetrically with respect to the optical axis, and an illumination pattern P1b (second illumination pattern) that turns on the adjacent second-group LEDs 41 constituting one half on the other side and turns off the remaining first-group LEDs 41. The first illumination direction and the second illumination direction are symmetric with respect to the optical axis. As described above, the multi-directional illumination pattern P1 includes the first illumination pattern (illumination pattern P1a) that illuminates the specimen 13 to be observed from the first illumination direction and the second illumination pattern (illumination pattern P1b) that illuminates the specimen 13 from the second illumination direction different from the first illumination direction.

Similarly, as illustrated in FIG. 3, the multi-directional illumination patterns P2 and P3 also include one illumination pattern (first illumination pattern) in which the adjacent first-group LEDs 41 constituting one half of the LEDs are turned on and the remaining second-group LEDs 41 are turned off, and the other illumination pattern (second illumination pattern) in which the turning on/off of the LEDs 41 turned on or off in the one first illumination pattern is switched and the LEDs 41 are turned on or off. That is, each of the multi-directional illumination patterns P1 to P4 includes a first illumination pattern that illuminates the specimen 13 from the first illumination direction and a second illumination pattern that illuminates the specimen 13 from the second illumination direction that is symmetric to the first illumination direction with respect to the optical axis. Then, the multi-directional illumination patterns P1 to P4 illuminate the specimen 13 from illumination directions whose angles are changed around the optical axis. That is, the multi-directional illumination patterns P2 to P4 are obtained by sequentially rotating the first and second illumination directions of the first illumination pattern and the second illumination pattern of the multi-directional illumination pattern P1 by a predetermined angle around the optical axis.

Note that the illumination patterns in FIG. 3 are an example, and a first illumination pattern and a second illumination pattern different from those in FIG. 3 may be adopted, and a multi-directional illumination pattern for performing illumination from an illumination direction other than the multi-directional illumination patterns P1 to P4 may be adopted.

The imaging device 30 is, for example, a digital camera including an imaging unit including an imaging element such as a complementary metal-oxide-semiconductor (CMOS) image sensor or a charge-coupled device (CCD) image sensor. The imaging device 30 is hardware. Imaging of the imaging unit of the imaging device 30 is controlled by an imaging control signal from the control unit 21. The imaging device 30 receives light (broken line) from the specimen 13 that is incident through the objective lens 11 on a light receiving surface of the imaging unit, and photoelectrically converts an optical image of the light receiving surface to obtain an imaging signal. The imaging device 30 obtains a captured image by predetermined signal processing on the imaging signal. The captured image from the imaging device 30 is supplied to the host device 20.

The host device 20 can be configured by, for example, a computer including a processor and a memory. The host device 20 controls the operation of the microscope 10 by the processor executing a program stored in the memory. The input unit 22 includes an operation unit such as a keyboard, a mouse, or a dedicated controller (not illustrated), receives a user operation, and supplies an operation signal to the control unit 21. The display unit 23 includes a display device such as a liquid crystal display (LCD), and is controlled by the control unit 21 to perform various displays.

The user of the microscope system 1 may input a command to the host device 20 by operating the input unit 22 while viewing the application screen displayed on the display unit 23, and the host device 20 may control the microscope 10 according to the command input by the user.

In a case of generating a shaded image, the control unit 21 outputs the imaging control signal and a light emission control signal for illuminating the specimen 13 from different illumination directions and imaging the specimen 13, to the imaging device 30 and the illumination device 40. The control unit 21 provides the captured image thus obtained to the image composition unit 24. The image composition unit 24 performs normal calculation using the photometric stereo method on a plurality of captured images (hereinafter, referred to as a plurality of captured images in different illumination directions) of the specimen 13 obtained by being illuminated from mutually different illumination directions. The image composition unit 24 combines a plurality of captured images in different illumination directions by assigning brightness and darkness according to the inclination of the normal vector of the observation target obtained by the photometric stereo method, thereby constructing a shaded image caused only by a shape and not affected by texture or reflection of light.

In creating such a shaded image, Patent Literature 1 has a disadvantage that it takes a long time to acquire a plurality of captured images in different illumination directions, and as a result, it takes a long time to create the shaded image.

Therefore, in the present embodiment, the illumination direction is switched in synchronization with the exposure of the imaging device 30, and the exposure processing of the imaging device 30 and the signal processing for the imaging signal are performed in parallel, thereby reducing the time required to create the shaded image.

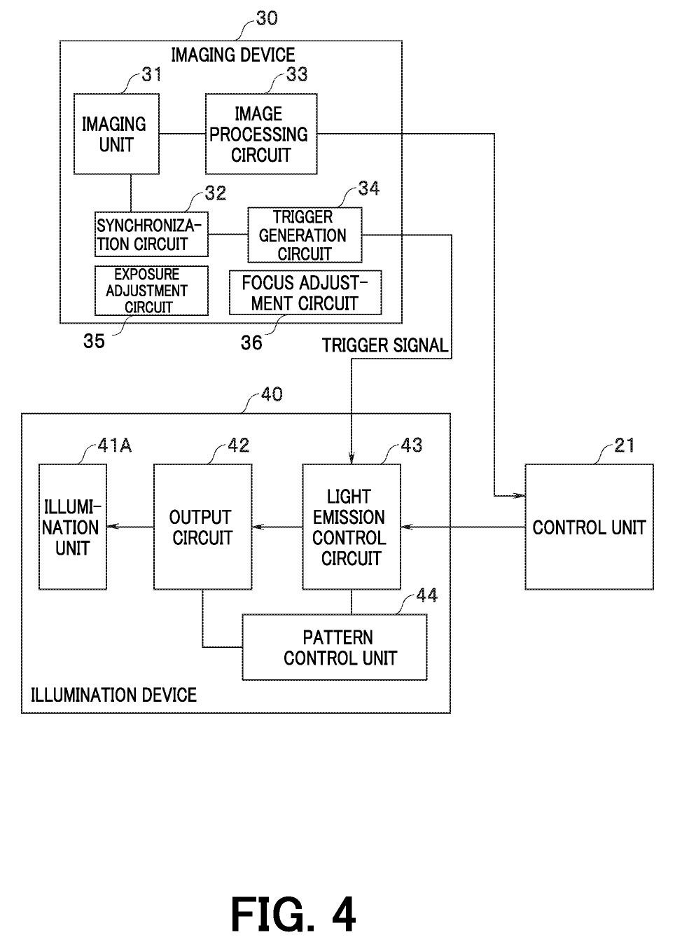

FIG. 4 is a block diagram illustrating an example of configurations of the imaging device 30 and the illumination device 40.

The imaging device 30 includes an imaging unit 31, a synchronization circuit 32, an image processing circuit 33, a trigger generation circuit 34, an exposure adjustment circuit 35, and a focus adjustment circuit 36. The imaging unit 31 performs exposure in synchronization with a frame synchronization signal generated by the synchronization circuit 32. An imaging signal obtained by photoelectric conversion in the exposure period is supplied to the image processing circuit 33. The image processing circuit 33 obtains a captured image of the specimen 13 by predetermined signal processing on the imaging signal. This captured image is supplied to the control unit 21 of the host device 20.

Note that the image processing circuit 33 enables it possible to determine by which illumination pattern of the first and second illumination patterns the image of each frame is illuminated and obtained by adding a frame number to the image. The control unit 21 collates the multi-directional illumination pattern designated for the illumination device 40 with the frame number to identify from which direction the acquired image is illuminated and captured. On the basis of this identification result, the image composition unit 24 can reliably create a shaded image using a pair of first and second illumination patterns.

Note that the image composition unit 24 may perform image composition by removing halation by selecting or combining pixels on the basis of the magnitudes of the luminance values of the pixels. Furthermore, the image composition unit 24 may construct a shaded image by setting a virtual light source direction and combining images on the basis of the virtual light source direction and the normal vector.

In the present embodiment, the imaging device 30 is provided with the trigger generation circuit 34, and the trigger generation circuit 34 generates a trigger signal synchronized with the end timing of the exposure period on the basis of the output of the synchronization circuit 32. That is, the trigger signal is a signal synchronized with the frame, and is generated at a frame rate (for example, 60 fps (frames per second)). The trigger generation circuit 34 outputs the generated trigger signal to the illumination device 40.

The exposure adjustment circuit 35 is a circuit that adjusts the exposure time of the imaging unit 31, and the focus adjustment circuit 36 is a circuit that performs focus adjustment of the imaging unit 31.

The illumination device 40 includes an illumination unit 41A, an output circuit 42, a light emission control circuit 43, and a pattern control unit 44. The output circuit 42 individually drives each LED 41 of the illumination unit 41A to turn each LED 41 on or off. The light emission control circuit 43 controls the output circuit 42 to individually control the lighting timing of each LED 41. The pattern control unit 44 includes, for example, a memory (not illustrated) that holds information of an illumination pattern for performing illumination with each illumination pattern in FIG. 3. The illumination pattern is instructed by the light emission control signal of the control unit 21, and the light emission control circuit 43 controls the output circuit 42 on the basis of the information of the pattern control unit 44 to cause the illumination unit 41A to emit light with a predetermined illumination pattern.

In the present embodiment, the trigger signal is input from the imaging device 30 to the light emission control circuit 43. The light emission control circuit 43 switches the illumination pattern of the illumination unit 41A based on the trigger signal. As a result, the illumination pattern of the illumination unit 41A is switched in synchronization with the end timing of the exposure period. Note that, in order to prevent illumination with different illumination patterns from being performed in one exposure period for acquiring an image of one frame, the light emission control circuit 43 performs control to turn off the illumination unit 41A at the generation timing of the trigger signal and then cause the illumination unit 41A to emit light with an illumination pattern for the next frame.

Note that the LED 41 is actually turned on after a predetermined response time caused by rise and fall of the lighting and the like, in response to the turn-on/off control of the light emission control circuit 43. In many cases, the exposure hardly occupies the entire period of one frame, and the response time can be set to a period other than the exposure period by switching the illumination pattern at the end of the exposure. Thus, in the present embodiment, the illumination pattern is switched at the frame rate, and illumination with a different illumination pattern is performed for each frame of imaging by the imaging device 30.

In a period during which exposure of a predetermined frame is performed in the imaging unit 31 of the imaging device 30, for example, signal processing is performed by the image processing circuit 33 on an imaging signal obtained by exposure of a previous frame. The captured image obtained by the signal processing is transferred to the host device 20 in the next frame period, for example. That is, in the present embodiment, the imaging device 30 can perform imaging (live imaging) while operating live. Note that imaging while operating live refers to moving image capturing in which the imaging device 30 continuously operates during imaging to record a video in real-time.

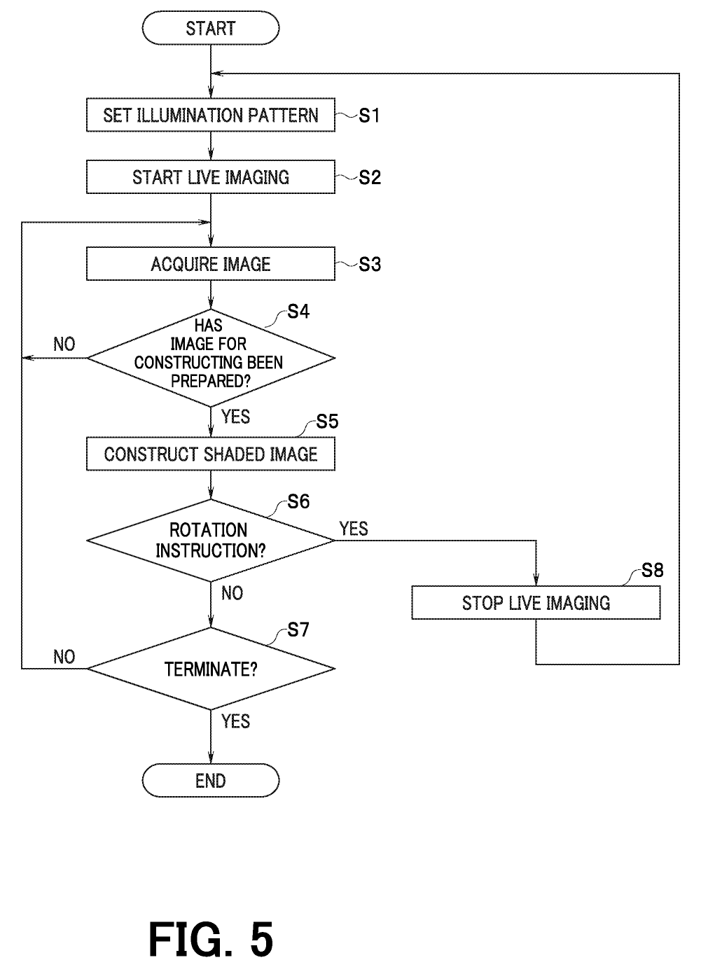

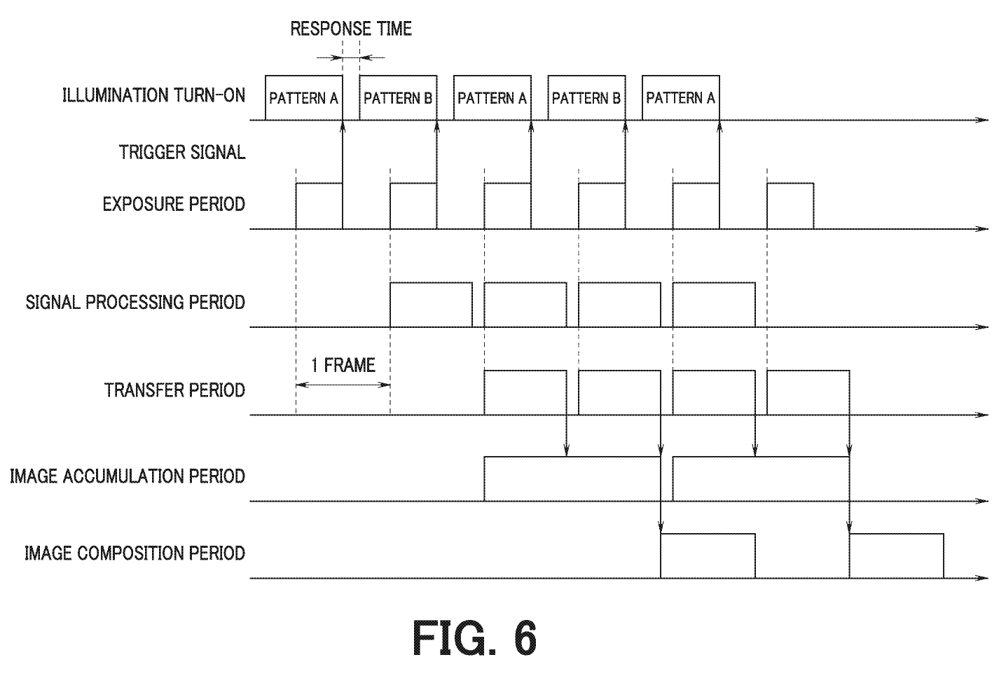

Next, the operation of the embodiment configured as described above will be described with reference to FIGS. 5 and 6. FIG. 5 is a flowchart for explaining the operation of the first embodiment, and FIG. 6 is a timing chart for explaining the operation of the first embodiment. FIG. 6 illustrates an illumination pattern, a trigger signal, an exposure period, a signal processing period, a transfer period, an image accumulation period, and an image composition period.

In S1 of FIG. 5, the control unit 21 sets an illumination pattern for the imaging device 30. For example, the control unit 21 sets one of the multi-directional illumination patterns P1 to P4 in FIG. 3 by the light emission control signal. The information about the setting of the illumination pattern is stored in the memory of the pattern control unit 44. Next, the control unit 21 outputs the imaging control signal to the imaging device 30 to start live imaging (S2), and acquires a captured image of the specimen 13 (S3).

That is, the synchronization circuit 32 generates a synchronization signal, and the imaging unit 31 operates on the basis of the synchronization signal and starts exposure. In addition, the trigger generation circuit 34 generates a trigger signal in synchronization with the end timing of the exposure on the basis of the output of the synchronization circuit 32. The trigger signal is supplied to the light emission control circuit 43 of the illumination device 40. The light emission control circuit 43 controls the output circuit 42 to turn on the illumination unit 41A. In this case, the light emission control circuit 43 turns on the illumination unit 41A using the illumination pattern stored in the pattern control unit 44. As the illumination pattern, the first or second illumination pattern of a pair of any of the multi-directional illumination patterns P1 to P4 is used. In FIG. 6, these first and second illumination patterns are illustrated as a pattern A and a pattern B, respectively.

In the present embodiment, the light emission control circuit 43 turns off the lighting of the previous illumination pattern (pattern A or pattern B) of the illumination unit 41A at the timing of the trigger signal from the imaging device 30, and causes the illumination unit 41A to emit light with the next illumination pattern (pattern B or pattern A). As illustrated in FIG. 6, the trigger signal is generated at the end timing of the exposure period, and in the exposure period for acquiring an image of one frame, imaging is performed by exposure with illumination of either pattern A or pattern B. That is, when an imaging signal is obtained by illumination with the pattern A (for example, the illumination pattern P1a) in a predetermined frame, an imaging signal is obtained by illumination with the pattern B (for example, the illumination pattern P1b) in the next frame. Thereafter, imaging using illumination of the pattern A and imaging using illumination of the pattern B are switched every frame period. In this way, a plurality of imaging signals in different illumination directions are obtained for each frame.

In such live imaging, the imaging signal from the imaging unit 31 is subjected to signal processing in the image processing circuit 33 and a captured image is obtained in the next frame period after exposure. That is, signal processing of the imaging signal obtained by the exposure by the pattern B one frame before is simultaneously performed in the frame period in which the exposure by the pattern A is performed, and similarly, signal processing of the imaging signal obtained by the exposure by the pattern A one frame before is simultaneously performed in the frame period in which the exposure by the pattern B is performed. In this way, at the time of live imaging, exposure and signal processing are performed in parallel, and a captured image is obtained.

This captured image is transferred to the host device 20 in a frame next to the frame period in which the signal processing has been performed, and is accumulated in a memory 24a of the image composition unit 24. The control unit 21 determines whether images for constructing the shaded image have been prepared (stored in the memory 24a) (S4), and in a case where the images have not been prepared, returns the processing to S3 and waits for the preparation of the captured images. In the example of FIG. 6, for example, when the control unit 21 determines that the captured image by the illumination of pattern A and the captured image by the illumination of pattern B are stored in the memory 24a by collating the frame number with the illumination pattern (YES in S4), the processing proceeds to S5.

In S5, the control unit 21 instructs the image composition unit 24 to construct the shaded image using the captured image by the illumination of the patterns A and B stored in the memory 24a. The image composition unit 24 constructs a shaded image using the captured image by the illumination of the patterns A and B. The shaded image is provided and displayed on the display unit 23.

Note that, in a case where there is an instruction from the user, the control unit 21 may store the image by the illumination of the pattern A or the pattern B in the memory 24a while shifting the image by several pixels. In this case, the image composition unit 24 performs image composition in a state where pixels of at least one of the two captured images by the illumination of the patterns A and B are shifted, and the shading of the texture of the shaded image is strengthened by the image composition of the image composition unit 24, and there is an effect that scratches and the like of the specimen are easily seen.

Furthermore, in the shaded image constructed by the image composition unit 24, shading changes by using multi-directional illumination patterns having different illumination directions, and appearance of the shaded image displayed on the display unit 23 changes. Therefore, the user may operate the input unit 22 to switch the currently set multi-directional illumination pattern and rotate the illumination direction. In S6, the control unit 21 determines whether or not there is such a rotation instruction. When there is no rotation instruction (NO in S6), the control unit 21 determines whether or not to end in S7. The control unit 21 returns the processing to S3 in a case where termination is not instructed, and terminates the processing in a case where termination is instructed.

When there is the rotation instruction (YES in S6), control unit 21 stops the live imaging in S8, and then returns the processing to S1 to set the multi-directional illumination pattern different from the multi-directional illumination pattern currently being set. Thereafter, the operations of S1 to S8 are repeated. In the rotation instruction, for example, when the first and second illumination directions of the multi-directional illumination pattern are rotated by 45 degrees each, the multi-directional illumination patterns P1, P2, P3, P4, P1, P2,... may be switched in this order.

By changing the direction of illumination of the multi-directional illumination pattern in this manner, it is possible to change how the shading of the shaded image is formed, and it is possible to create a more easily viewable shaded image.

Note that the control unit 21 checks whether the pair of illumination patterns is prepared by collating the frame number with the illumination pattern as described above. For example, even in a case where an even-numbered frame is set as the first illumination pattern and an odd-numbered frame is set as the second illumination pattern, when the multi-directional illumination pattern is switched, the even-numbered frame may become the second illumination pattern and the odd-numbered frame may become the first illumination pattern, and a correct shaded image may not be created. Therefore, in FIG. 5, the live imaging is once stopped and then resumed at the time of switching the multi-directional illumination pattern, so that the correspondence relationship between the frame number and the illumination pattern does not deviate.

Note that, for example, in a case of performing control to switch to the next multi-directional illumination pattern after the first and second illumination patterns of the currently executed multi-directional illumination pattern are completed at the time of setting the illumination pattern, it is possible to continuously create the shaded image without performing the live imaging stop and restart processing in S8. Specifically, in a case where the multi-directional illumination pattern P1, an even-numbered frame being set as the illumination pattern P1a and an odd-numbered frame being set as the illumination pattern P1b, is switched to the multi-directional illumination pattern P3, an even-numbered frame being set as the illumination pattern P3a and an odd-numbered frame being set as the illumination pattern P3b, the even-numbered frame may become the illumination pattern P3b and the odd-numbered frame may become the illumination pattern P3a, depending on the switching timing. Therefore, when there is a rotation instruction, the control unit 21 is only required to switch to the multi-directional illumination pattern P3 after imaging of the illumination pattern P1a of the even-numbered frame and the illumination pattern P1b of the odd-numbered frame is completed.

Note that the image processing circuit 33 of the imaging device 30 may directly add information regarding the illumination direction to the image. For example, the image processing circuit 33 may include an information addition circuit that receives an image of the imaging unit 31 and information on the illumination direction from the illumination device 40 and directly adds the information on the illumination direction to the image. Note that such an information addition circuit does not need to be provided in the imaging device 30, and may be provided at any position of the microscope system 1. According to this configuration, since the control unit 21 does not need to collate the image with the illumination direction, the illumination pattern can be switched without stopping live imaging in S8. That is, the control unit 21 reads information on the illumination direction added to the input captured image, and instructs the image composition unit 24 to combine images on the basis of the information. As a result, the image composition unit 24 can combine images using a plurality of captured images necessary for creating a shaded image.

As described above, in the present embodiment, during live imaging by the imaging device, imaging with different illumination patterns is performed in a frame cycle in which exposure is performed, and signal processing of imaging signals is performed in parallel, whereby a plurality of captured images in different illumination directions necessary for a shaded image can be acquired, and a shaded image can be generated at an extremely high speed. In addition, even at the time of switching the multi-directional illumination pattern, it is possible to reliably acquire a plurality of captured images necessary for generating a shaded image, and it is possible to easily acquire a more easily viewable shaded image.

### Modifications

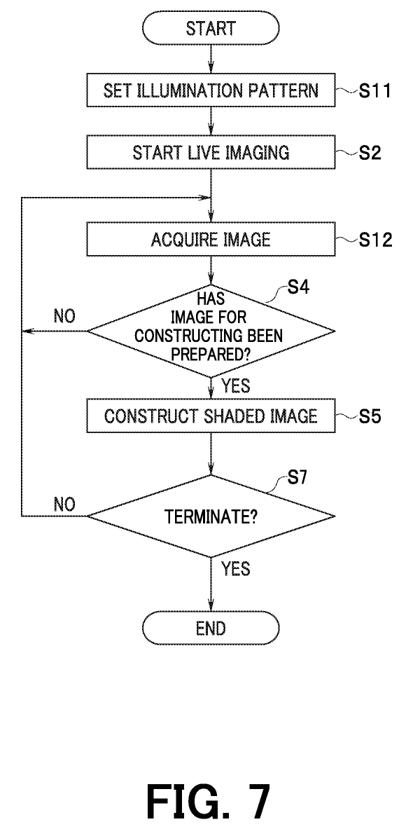

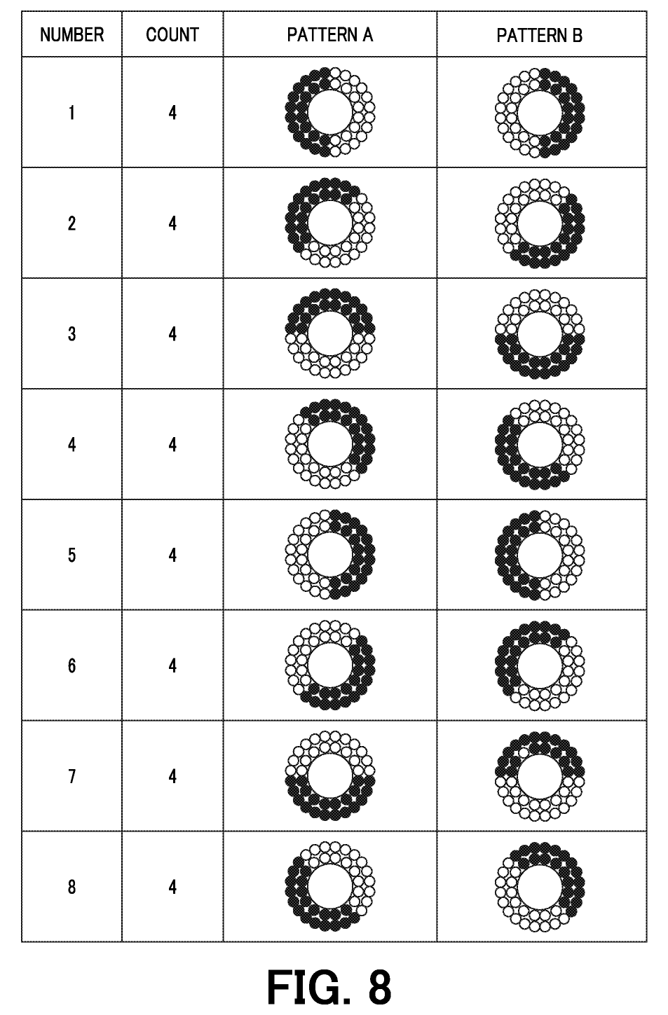

FIGS. 7 and 8 illustrate modifications of the first embodiment. FIG. 7 is a flowchart illustrating the modification, and FIG. 8 is an explanatory diagram illustrating the modification. In FIG. 7, the same procedures as those in FIG. 5 are denoted by the same reference numerals, and description thereof is omitted. A hardware configuration of the present modification is similar to that of the first embodiment. In the example of FIG. 5, control is performed to rotate the illumination direction of the multi-directional illumination pattern based on the user operation. On the other hand, the present modification enables the rotation of the illumination direction of the multi-directional illumination pattern to be automatically performed.

Irradiation of the first and second illumination patterns with one multi-directional illumination pattern may be performed only once, or may be repeated a plurality of times as in the first embodiment. In the present modification, such one or a plurality of times of irradiation of the first and second illumination patterns is repeatedly performed while rotating the first and second illumination directions by a predetermined angle around the optical axis. That is, the multi-directional illumination pattern is sequentially rotated about the optical axis.

In the present modification, all the illumination patterns of the multi-directional illumination pattern are set at the time of setting the illumination pattern in S11. FIG. 8 illustrates a table defining the multi-directional illumination patterns to be set and the changes of the illumination direction. The table of FIG. 8 illustrates an example in which the first illumination pattern is a pattern A and the second illumination pattern is a pattern B. One multi-directional illumination pattern is configured by the pair of patterns A and B. The number field in the table indicates the order of the selected multi-directional illumination pattern, and the count field in the table indicates the number of repetitions of the patterns A and B of the selected multi-directional illumination pattern. That is, the illumination illustrated in the patterns A and B is repeated for the number of times as one set (one multi-directional illumination pattern), and then the illumination is performed with the multi-directional illumination pattern of the next number.

For example, in the example of FIG. 8, the illumination device 40 switches the illumination of the pattern A and the illumination of the pattern B of number 1 every time the trigger signal is received, repeats the illumination of the patterns A and B four times, and then repeats the illumination of the patterns A and B of number 2. Thereafter, when the set of the number 2 ends, the next number 3 is performed. Thereafter, similarly, when number 8 ends, the process returns to the number 1 to repeat the illumination of the patterns A and B.

The number of times in the table of FIG. 8 sets the rotation speed of the multi-directional illumination pattern in the illumination direction. For example, in a case where the imaging unit 31 is set at 60 fps, two patterns are repeated four times, and thus it is indicated that the pattern shifts to the multi-directional illumination pattern in the next illumination direction after eight trigger signals, that is, 8/60 seconds. The user can set the rotation speed, and sets a table in which the number of times is decreased when the rotation speed is increased and the number of times is increased when the rotation speed is decreased. Note that information on actual time may be used as the rotation speed, and in this case, the item of the number of times in the table is set as the switching time. That is, the first illumination pattern and the second illumination pattern rotate after a time designated based on the switching time information has elapsed. Note that the order and the number of times indicated by the patterns A and B and the numbers in FIG. 8 are examples, and the setting can be changed as appropriate.

The control unit 21 supplies the information of the table of FIG. 8 to the pattern control unit 44 of the illumination device 40. The present embodiment is different from the flow of FIG. 5 in that illumination is performed according to the table of FIG. 8 and image acquisition is performed in S12. Note that S6 and S8 in FIG. 5 are omitted since imaging using multi-directional illumination patterns in a plurality of illumination directions is performed in S12.

The other operations are similar to those in FIG. 5.

As described above, also in the present modification, the same effects as those of the first embodiment can be obtained. Furthermore, in the present modification, it is possible to automatically perform illumination using a plurality of multi-directional illumination patterns having different illumination directions to acquire a shaded image, and it is possible to generate a plurality of shaded images having different effects while omitting a complicated operation by the user.

### Second Embodiment

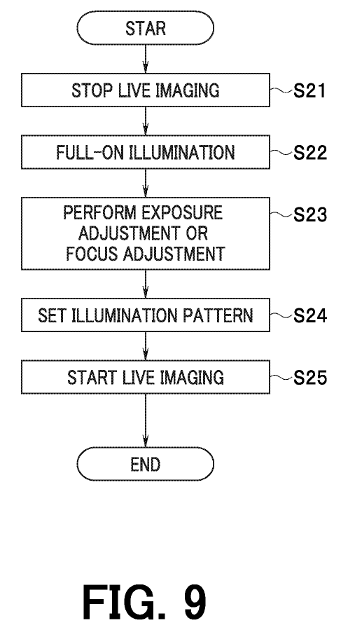

FIG. 9 is a flowchart for explaining a second embodiment. The hardware configuration of the present embodiment is similar to that of the first embodiment. The present embodiment is for performing adjustment of an appropriate exposure time and adjustment of focus.

For example, in a case where the position of the specimen 13 is changed, or the like, blown highlights or crushed blacks may occur, or defocus may occur. Therefore, adjustment of the exposure time and focus adjustment are performed as necessary. The present embodiment enables such exposure time and focus adjustment.

For example, at the time of execution of the shaded image generation loop of FIG. 5, in a case where the user operates the input unit 22 to instruct exposure time adjustment and focus adjustment, the flow of FIG. 9 is performed. In S21 of FIG. 9, the control unit 21 controls the imaging device 30 and the illumination device 40 to stop live imaging, stops generation of the trigger signal, and stops repetition of the illumination pattern. The control unit 21 performs full-on control of the illumination unit 41A (S22). Note that the control unit 21 does not necessarily need to cause the illumination unit 41A to be in the fully-on state, and the illumination unit 41A may be turned on in any illumination pattern, or may perform illumination using another illumination method such as coaxial illumination.

The control unit 21 performs exposure time adjustment and focus adjustment on the imaging device 30 in accordance with a user operation of the input unit 22 (S23). The exposure adjustment circuit 35 of the imaging device 30 adjusts the exposure time of the imaging unit 31 so that the average value of the luminance matches the target value, for example. Note that the required exposure time is different between illumination at the time of exposure time adjustment and illumination with an illumination pattern for acquiring a shaded image. Therefore, a correction coefficient for correcting a difference in brightness between illumination at the time of exposure time adjustment and illumination at the time of imaging for the shaded image may be calculated in advance and stored in a memory (not illustrated) of the exposure adjustment circuit 35. The exposure adjustment circuit 35 multiplies the exposure time obtained at the time of exposure time adjustment by the correction coefficient to obtain an appropriate exposure time at the time of imaging for the shaded image, and sets the exposure time in the imaging unit 31.

Furthermore, at the time of focus adjustment, the control unit 21 turns on the illumination unit 41A under the illumination condition for focus adjustment. In this state, the focus adjustment circuit 36 performs focus adjustment so as to obtain an appropriate focus. For example, the focus adjustment circuit 36 may perform the focus adjustment by a contrast autofocus method of searching for a position where the contrast is maximized while operating the focusing device 14. Furthermore, the focus adjustment circuit 36 may perform focus adjustment using various focus adjustment methods such as a confocal method and a pupil division method.

In S24, the control unit 21 resets the illumination pattern before the live imaging is stopped, starts the live imaging, and restarts the repetition of the illumination pattern (S25).

Other operations are similar to those in the first embodiment.

As described above, in the present embodiment, the deviation of the appropriate exposure time and the deviation of the focus when the visual field is moved can be adjusted without stopping the generation of the shaded image.

### Third Embodiment

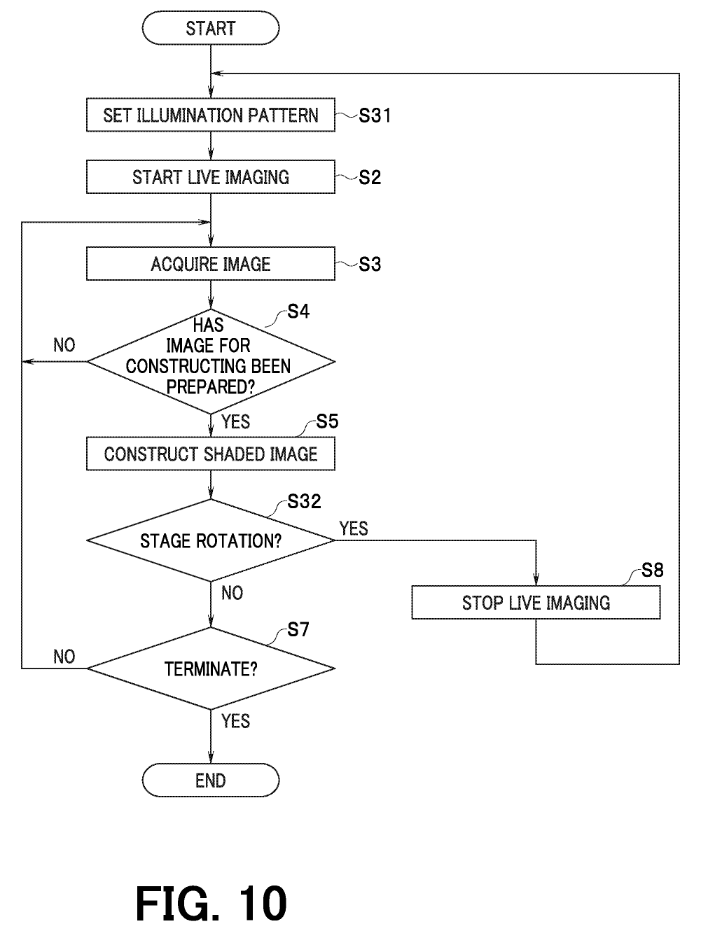

FIG. 10 is a flowchart for explaining a third embodiment. In FIG. 10, the same procedures as those in FIG. 5 are denoted by the same reference numerals, and description thereof is omitted. The hardware configuration of the present embodiment is similar to that of the first embodiment. In the present embodiment, the illumination pattern is set in accordance with the rotation of the stage.

As described above, the stage 12 is rotatable about the optical axis, and the rotation angle of the stage 12 can be detected by the rotary encoder 15. The rotary encoder 15 transfers the detection result of the rotation angle of the stage 12 to the control unit 21. In the present embodiment, the control unit 21 can set the illumination pattern on the basis of the detection result of the rotary encoder 15. For example, the control unit 21 switches the multi-directional illumination pattern in accordance with the rotation angle of the stage 12, so that the illumination of the first and second illumination patterns can be performed on the specimen 13 from the same illumination direction before and after the rotation of the stage 12.

FIG. 10 is different from FIG. 5 in that S31 is adopted instead of S1 and S32 is adopted instead of S6. In S32, the control unit 21 determines whether the stage 12 has rotated based on the output of the rotary encoder 15. When the stage 12 is not rotated, the process proceeds to S7. When the stage 12 is rotated (YES in S32), the process proceeds to S8 to stop live imaging, and then the process proceeds to S31.

In S31, the control unit 21 changes the multi-directional illumination pattern such that the illumination direction of the multi-directional illumination pattern is switched according to the rotation angle of the stage 12. Note that the control unit 21 can rotate the multi-directional illumination pattern at an arbitrary angle around the optical axis by individually controlling turning on/off of each LED 41. As a result, the control unit 21 enables the specimen 13 to be illuminated with the first and second illumination patterns from the same illumination direction before and after the rotation of the stage 12.

Other operations are similar to those in the first embodiment.

As described above, in the present embodiment, the illumination direction of the multi-directional illumination pattern is switched in accordance with the rotation of the stage, and even in a case where the specimen 13 is rotated by the stage 12, the shaded image can be generated by applying light to the specimen 13 from the same direction.

### Fourth Embodiment

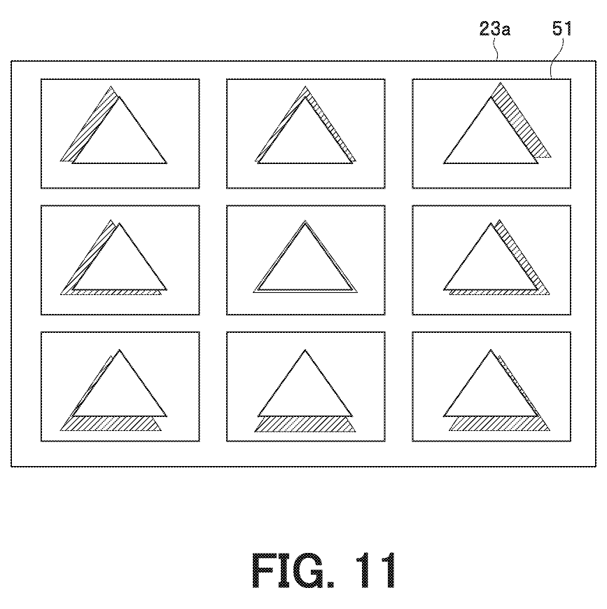

FIG. 11 is an explanatory diagram for explaining a fourth embodiment. The hardware configuration of the present embodiment is similar to that of the first embodiment, and the operation of creating a shaded image is similar to that of the modification of FIGS. 5 and 7. The present embodiment enables simultaneous display of a plurality of shaded images obtained by illumination with a plurality of multi-directional illumination patterns in different illumination directions.

The shaded image created by the image composition unit 24 is given to the display unit 23 and displayed. The display unit 23 includes a memory (not illustrated), and a plurality of shaded images created on the basis of a plurality of multi-directional illumination patterns having different illumination directions by the image composition unit 24 are stored in the memory of the display unit 23. The control unit 21 can control the display unit 23 to simultaneously display the plurality of shaded images stored in the memory of the display unit 23 on a display screen 23a of the display unit 23.

FIG. 11 illustrates a display example of a plurality of shaded image display regions 51 on the display screen of the display unit 23. FIG. 11 illustrates shading variation with hatching. Every time the shaded image is created by the image composition unit 24, the control unit 21 stores the shaded image in the memory and updates the display of the shaded image display region 51 corresponding to the direction of the shade.

In addition, a touch panel may be disposed on the display screen 23a of the display unit 23. The touch panel can detect a touch of the user by, for example, a capacitive method or the like, generates an operation signal corresponding to a position on a display screen pointed by the user with a finger or the like, and outputs the operation signal to the control unit 21. The user can designate a specific shaded image among the displayed shaded images in the shaded image display regions 51 by a touch operation.

The control unit 21 may, by receiving the operation signal from the touch panel, select, for example, a shaded image designated by the user and display the shaded image in the entire region of the shaded image display regions 51.

As described above, in the present embodiment, it is possible to confirm the shaded image obtained by being simultaneously illuminated by the plurality of multi-directional illumination patterns, and there is an advantage that the user can easily confirm the desired shaded image.

### Fifth Embodiment

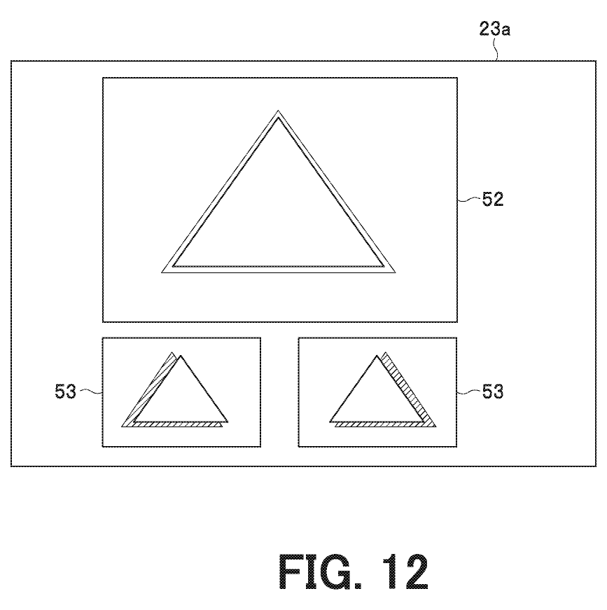

FIG. 12 is an explanatory diagram for explaining a fifth embodiment. The hardware configuration of the present embodiment is similar to that of the first embodiment, and the operation of creating a shaded image is similar to that of FIG. 5. In the present embodiment, a shaded image obtained by illumination with a multi-directional illumination pattern is displayed, and captured images that are a source of creation of the shaded image can be displayed simultaneously with the shaded image.

The display unit 23 includes a memory (not illustrated), and the control unit 21 stores, in the memory of the display unit 23, the shaded image created on the basis of the multi-directional illumination pattern by the image composition unit 24 and the captured images from which the shaded image has been created. The control unit 21 can control the display unit 23 to simultaneously display the shaded image stored in the memory of the display unit 23 and the two captured images from which the shaded image is created on the display screen 23a of the display unit 23.

FIG. 12 illustrates a display example of a shaded image display region 52 and two original image display regions 53 on the display screen of the display unit 23. As described above, the image composition unit 24 uses the two captured images illuminated and captured by the first illumination pattern and the second illumination pattern to create the shaded image. The control unit 21 provides the two captured images to the display unit 23 and causes the two captured images to be displayed in the two original image display regions 53, respectively. Furthermore, the control unit 21 causes the shaded image from the image composition unit 24 to be displayed in the shaded image display region 52.

As described above, in the present embodiment, the two captured images used for creating the shaded image and the shaded image can be simultaneously displayed. This makes it easier for the user to ascertain the state of the specimen.

### Console

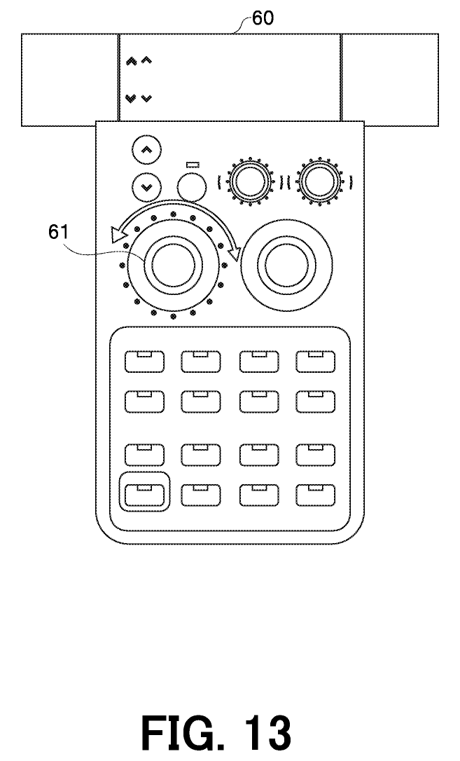

FIG. 13 is an explanatory diagram illustrating an example of the operation device 60 that can be employed as the input unit 22 of FIG. 1.

The operation device 60 is provided with various buttons and a plurality of knobs including a knob 61. The knob 61 outputs an operation signal corresponding to the rotation direction to control unit 21. For example, the control unit 21 may be configured to switch the multi-directional illumination pattern according to the operation of the knob 61. For example, when the user rotates the knob 61, the control unit 21 may be configured to switch the illumination pattern to the multi-directional illumination pattern with an illumination direction corresponding to the rotation angle of the knob 61.

The present disclosure is not limited to the above embodiments as it is, and can be embodied by modifying components without departing from the gist of the present disclosure at an implementation stage. In addition, various inventions can be formed by appropriately combining a plurality of constituent elements disclosed in the above embodiments. For example, some of all the components shown in the embodiments may be deleted. Furthermore, components in different embodiments may be combined as appropriate.

In addition, among the techniques described here, most of the control and functions mainly described in the flowcharts can be set by a program, and the control and functions described above can be realized by a computer reading and executing the program. The program can be recorded or stored in whole or in part in a portable medium such as a nonvolatile memory such as a flexible disk or a compact disk read only memory (CD-ROM) or a storage medium such as a hard disk or a volatile memory as a computer program product, and can be distributed or provided at the time of product shipment or via a portable medium or a communication line. The portable medium and the storage medium are examples of a non-transitory computer-readable recording medium. The user can easily realize the microscope system and the shaded image acquisition method of the present embodiment by downloading the program via the communication network and installing the program on the computer or installing the program from a portable medium in the computer.

What is claimed is:

1. A microscope system comprising:
an optical system including an objective lens;
an imaging device configured to sequentially acquire images of an observation target via the optical system at a predetermined frame rate and sequentially output trigger signals synchronized with frames during acquisition of the images of the observation target;
an illumination device configured to perform non-coaxial epi-illumination capable of irradiating the observation target with illumination light from a plurality of illumination directions rotated about an optical axis of the objective lens around the optical axis, the illumination device configured to receive the trigger signals output from the imaging device and switch the illumination directions according to the trigger signals; and
a computer configured to combine the images of the observation target acquired by the imaging device, the computer configured to generate a composite image representing a shape of the observation target on the basis of a plurality of images of the observation target acquired when the observation target is irradiated with the illumination light from the plurality of illumination directions.

2. The microscope system according to claim 1, wherein
the trigger signals are output to designate timing so that the illumination directions are switched in a period other than an exposure period in which an image of each frame of the observation target is acquired.

3. The microscope system according to claim 1, wherein
the trigger signals are output at an end timing of exposure in acquisition of an image of each frame of the observation target.

4. The microscope system according to claim 1, wherein
the plurality of illumination directions are a first illumination direction and a second illumination direction that is symmetric to the first illumination direction with respect to the optical axis, and
the illumination device alternately switches between irradiating the observation target with the illumination light from the first illumination direction and irradiating the observation target with the illumination light from the second illumination direction that is symmetric to the first illumination direction with respect to the optical axis in accordance with the trigger signals.

5. The microscope system according to claim 1, wherein
the computer generates, as the composite image, a shaded image with shading representing a shape of the observation target, with the plurality of images of the observation target acquired when the observation target is irradiated with the illumination light from the plurality of illumination directions as a set.

6. The microscope system according to claim 5, wherein
the computer calculates a normal vector of the observation target by a photometric stereo method, and generates the shaded image by assigning brightness and darkness according to an inclination of the normal vector.

7. The microscope system according to claim 1, wherein
the computer selects or combines a pixel based on a magnitude of a luminance value of the pixel.

8. The microscope system according to claim 6, wherein
the computer further receives a virtual light source direction and combines an image based on the virtual light source direction.

9. The microscope system according to claim 5, wherein
the computer generates the shaded image by shifting pixels of at least one image of input images.

10. The microscope system according to claim 1, wherein
the illumination device includes a plurality of multi-directional illumination patterns that irradiates the observation target with the illumination light from a plurality of different directions,
the imaging device adds a frame number to an image of the observation target, and
the computer is given an identification result indicating from which illumination direction the observation target is illuminated to capture an image on the basis of the frame number and the plurality of multi-directional illumination patterns of the illumination device, and generates the composite image on the basis of the identification result.

11. The microscope system according to claim 1, further comprising an information addition circuit configured to receive an image from the imaging device, receive information on an illumination direction from the illumination device, and add the information on the illumination direction to the received image,
wherein the computer generates the composite image on the basis of the information on the illumination direction added to the image.

12. The microscope system according to claim 1, wherein
the illumination device sequentially rotates about the optical axis a first illumination pattern that irradiates the observation target with the illumination light from a first illumination direction and a second illumination pattern that irradiates the observation target with the illumination light from a second illumination direction by performing one or a plurality of times of irradiation of the first illumination pattern and the second illumination pattern while rotating the first illumination direction and the second illumination direction about the optical axis by a predetermined angle, and
the computer sequentially generates a plurality of composite images for each rotation angle by using images obtained while sequentially rotating the first illumination pattern and the second illumination pattern about the optical axis.

13. The microscope system according to claim 12, wherein
the first illumination pattern and the second illumination pattern are rotated after repeating irradiation of the first illumination pattern and the second illumination pattern an instructed number of times.

14. The microscope system according to claim 12, wherein
the first illumination pattern and the second illumination pattern are rotated after an instructed time elapses.

15. The microscope system according to claim 12, wherein
the computer displays the plurality of composite images generated for each rotation angle by dividing the plurality of composite images into display regions corresponding to rotation angles.

16. The microscope system according to claim 12, wherein
the computer displays a first image of the observation target obtained by irradiation with the first illumination pattern, a second image of the observation target obtained by irradiation with the second illumination pattern, and the composite image generated by the computer on the basis of the first image and the second image in a divided manner on a display screen.

17. The microscope system according to claim 12, further comprising an exposure adjustment circuit configured to adjust an exposure time of the imaging device,
wherein the exposure adjustment circuit obtains the exposure time of the imaging device in a state where a plurality of times of irradiation of the first illumination pattern and the second illumination pattern is temporarily stopped and the illumination device is turned on under an illumination condition for adjustment, adjusts the exposure time by multiplying the obtained exposure time by a correction coefficient corresponding to the illumination condition for adjustment and an illumination condition of the first illumination pattern and the second illumination pattern, and then resumes the plurality of times of irradiation of the first illumination pattern and the second illumination pattern.

18. The microscope system according to claim 12, further comprising:
a focusing device configured to adjust a focus of the observation target that formed into an image on the imaging device; and
a focus adjustment circuit configured to adjust the focusing device so that the observation target is focused,
wherein the focus adjustment circuit performs a focus adjustment in a state where a plurality of times of irradiation of the first illumination pattern and the second illumination pattern is temporarily stopped and the illumination device is turned on under an illumination condition for adjustment, and then resumes the plurality of times of irradiation of the first illumination pattern and the second illumination pattern.

19. The microscope system according to claim 17, wherein
the illumination condition for adjustment is a condition for bringing the illumination device into a fully-on state.

20. The microscope system according to claim 17, wherein
the illumination condition for adjustment is a condition for performing illumination with one of the first illumination pattern and the second illumination pattern.

21. The microscope system according to claim 17, wherein
the illumination condition for adjustment is a condition for performing illumination with illumination other than the illumination device.

22. A microscope system comprising:
an imaging device configured to acquire images of an observation target at a predetermined frame rate and sequentially output trigger signals synchronized with frames at an end of exposure of each frame;
an illumination device configured to perform illumination with a multi-directional illumination pattern for irradiating the observation target with light from at least two different directions while changing an irradiation direction with respect to the observation target every time a trigger signal is received, and capable of changing an angle of the irradiation direction of light of the multi-directional illumination pattern;
a rotation stage on which the observation target is placed and rotatable about an optical axis of an optical system of the imaging device; and
a computer configured to generate a composite image by combining at least two images obtained by imaging, by the imaging device, the observation target illuminated from the at least two different directions with the multi-directional illumination pattern,
wherein the two images are obtained by live imaging of the imaging device, the computer sequentially generates the composite image with two images by the multi-directional illumination pattern as a set, and the illumination device changes the angle of the irradiation direction of light of the multi-directional illumination pattern so that the illumination direction with respect to the observation target does not change before and after rotation of the rotation stage.

23. A shaded image acquisition method of a microscope system including an imaging device, an illumination device, and a computer, the method comprising:
sequentially acquiring, by the imaging device, images of an observation target at a predetermined frame rate, and sequentially outputting, by the imaging device, trigger signals synchronized with frames during acquisition of the images of the observation target;
performing, by the illumination device, non-coaxial epi-illumination to irradiate the observation target with illumination light, receiving, by the illumination device, the trigger signals output from the imaging device, and switching, by the illumination device and according to the trigger signals, between irradiating the observation target with the illumination light from a first illumination direction and irradiating the observation target with the illumination light from a second illumination direction that is symmetric to the first illumination direction with respect to an optical axis of an optical system of the imaging device; and
generating, by the computer, a shaded image with shading representing a shape of the observation target as a composite image by combining an image of the observation target acquired when the observation target is irradiated with the illumination light from the first illumination direction and an image of the observation target acquired when the observation target is irradiated with the illumination light from the second illumination direction.

24. A non-transitory computer-readable recording medium having stored therein a shaded image acquisition program that causes a computer to perform a process comprising:
causing an imaging device that sequentially acquires images of an observation target at a predetermined frame rate to sequentially output trigger signals synchronized with frames during acquisition of the images of the observation target; and
causing an illumination device that performs non-coaxial epi-illumination to irradiate the observation target with illumination light to switch between irradiating the observation target with the illumination light from a first illumination direction and irradiating the observation target with the illumination light from a second illumination direction that is symmetric to the first illumination direction with respect to an optical axis of an optical system of the imaging device, according to the trigger signals output from the imaging device, and
combining an image of the observation target acquired when the observation target is irradiated with the illumination light from the first illumination direction and an image of the observation target acquired when the observation target is irradiated with the illumination light from the second illumination direction to generate a shaded image with shading representing a shape of the observation target as a composite image.
